(19) United States
(12) Patent Application Publication
(10) Pub. No.: US 2026/0040116 A1
(43) Pub. Date: Feb. 5, 2026

(54) PREDICTED RADIO RESOURCE MANAGEMENT (RRM) MEASUREMENT CONFIGURATION AND REPORTING

(71) Applicant: InterDigital Patent Holdings, Inc., Wilmington, DE (US)

(72) Inventors: Oumer Teyeb, Montreal (CA); Brian Martin, Farnham (GB); Yugeswar Deenoo Narayanan Thangaraj, Chalfont, PA (US); Dylan Watts, Montreal (CA)

(73) Assignee: InterDigital Patent Holdings, Inc., Wilmington, DE (US)

(21) Appl. No.: 18/794,932

(22) Filed: Aug. 5, 2024

(51) Int. Cl. H04W 24/10

(52) U.S. Cl. CPC H04W 24/10

(57) ABSTRACT

A method performed by a wireless transmit receive unit (WTRU), including sending an indication of WTRU radio resource management (RRM) measurement prediction capabilities to a network. Configuration information is received by the WTRU, and the configuration information includes information associated with RRM or predicted RRM measurements, a condition associated with the RRM measurements, and information to be included in an RRM measurement report. A first predicted RRM measurement is determined. It is determined that a first RRM measurement fulfills the condition associated with the RRM measurements. A second predicted RRM measurement is determined based on the first RRM measurement fulfilling the condition associated with the RRM measurements. The second predicted RRM measurement is associated with a different cell, frequency, or time than the first RRM measurement. An RRM measurement report is sent to the network, and includes information associated with the second predicted RRM measurement.

### BACKGROUND

In New Radio (NR), when a Wireless Transmit/Receive Unit (WTRU) is in a Radio Resource Control (RRC)_CONNECTED state, it may measure the signal level of one or more beams of a cell, and the measurement results may be averaged to derive the cell quality. The WTRU may be configured to consider a subset of the detected beams. Filtering may occur at two levels, including at the physical layer (L1) level to derive beam quality, and then at the RRC (L3) level to derive cell quality from multiple beams. Cell quality from beam measurements may be derived in the same way for the serving cells and for the non-serving cells. Measurement reports may include the measurement results of the X best beams if the WTRU is configured to do so by the Next Generation Node B (gNB).

### SUMMARY

A method performed by a wireless transmit receive unit (WTRU). The method comprises sending an indication of radio resource management (RRM) measurement prediction capabilities of the WTRU to a network. Configuration information is received, wherein the configuration information comprises information relating to RRM measurements or predicted RRM measurements, wherein the configuration information comprises a condition associated with the RRM measurements, and wherein the configuration information comprises information to be included in an RRM measurement report. The method comprises determining a first predicted RRM measurement and determining that a first RRM measurement fulfills the condition associated with the RRM measurements. A second predicted RRM measurement is determined based on the first RRM measurement fulfilling the condition associated with the RRM measurements. The second predicted RRM measurement is associated with a different cell, a different frequency, or a different time than the first RRM measurement. The RRM measurement report is sent to the network, wherein the RRM measurement report comprises information associated with the second predicted RRM measurement.

The configuration information comprises a condition associated with the predicted RRM measurements. The method further comprises determining that the first predicted RRM measurement fulfills the condition associated with the predicted RRM measurements, and determining a second RRM measurement based on the first predicted RRM measurement fulfilling the condition associated with the predicted RRM measurements, wherein the second RRM measurement is associated with a different cell, a different frequency, or a different time than the first predicted RRM measurement, wherein the RRM measurement report comprises information associated with the second RRM measurement.

The second predicted RRM measurement is determined based on the first predicted RRM measurement.

The condition associated with the RRM measurements comprises a measured cell quality of a serving cell being below a threshold, a measured cell quality of a neighboring cell being above a threshold, or a measured cell quality of the serving cell below less than a measured cell quality of a neighboring cell by a threshold amount.

The condition associated with the predicted RRM measurements comprises a predicted cell quality of a serving cell being below a threshold, a predicted cell quality of a neighboring cell being above a threshold, or a predicted cell quality of the serving cell below less than a predicted cell quality of a neighboring cell by a threshold amount.

The indication of radio resource management (RRM) measurement prediction capabilities comprises an indication of one or more frequencies supported by the WTRU, an indication of one or more cells that can be predicted by the WTRU, or an indication of a beam prediction type supported by the WTRU.

The RRM measurement report comprises a number of predicted RRM measurement samples and an indication of that the predicted RRM measurement samples are predicted RRM measurement samples.

The RRM measurement report comprises a number of predicted RRM measurement samples that have the highest cell quality, a mean or median of a plurality of predicted RRM measurement samples associated with a prediction time window, or an indication of a range of a plurality of predicted RRM measurement samples.

The first RRM measurement is associated with a first cell or first beam and is associated with a first time instance, and the second predicted RRM measurement is associated with a second cell or second beam and is associated with a second time instance.

The information to include in the RRM measurement report comprises an indication of a reporting periodicity for the RRM measurements or the predicted RRM measurements, an indication of a number of the predicted RRM measurements to include in the RRM measurement report, or a condition that triggers the WTRU to skip the sending of the RRM measurement report.

The first RRM measurement is determined for a first cell or beam and the second predicted RRM measurement is determined for a second cell or beam based on the first RRM measurement of the first cell or beam. The method further comprises sending a request for a measurement configuration for the first cell or beam, receiving reference signals (RSs) associated with the first cell or beam, and determining the first RRM measurement for the first cell or beam based on the RSs.

The configuration information comprises information regarding triggering of an RRM measurement report, wherein the information regarding triggering of the RRM report comprises a reporting periodicity and whether to skip the sending of the RRM measurement report.

A wireless transmit/receive unit (WTRU), comprising a processor. The processor is configured to send an indication of radio resource management (RRM) measurement prediction capabilities of the WTRU to a network. Configuration information is received, wherein the configuration information comprises information relating to RRM measurements or predicted RRM measurements, wherein the configuration information comprises a condition associated with the RRM measurements, and wherein the configuration information comprises information to be included in an RRM measurement report. A first predicted RRM measurement is determined, and it is determined that a first RRM measurement fulfills the condition associated with the RRM measurements. A second predicted RRM measurement is determined based on the first RRM measurement fulfilling the condition associated with the RRM measurements, wherein the second predicted RRM measurement is associated with a different cell, a different frequency, or a different time than the first RRM measurement. The RRM measurement report is sent to the network, wherein the RRM measurement report comprises information associated with the second predicted RRM measurement.

The configuration information comprises a condition associated with the predicted RRM measurement. The processor is configured to determine that the first predicted RRM measurement fulfills the condition associated with the predicted RRM measurements, and to determine a second RRM measurement based on the first predicted RRM measurement fulfilling the condition associated with the predicted RRM measurements. The second RRM measurement is associated with a different cell, a different frequency, or a different time than the first predicted RRM measurement, and the RRM measurement report comprises information associated with the second RRM measurement.

The second predicted RRM measurement is determined based on the first predicted RRM measurement.

The condition associated with the RRM measurements comprises a measured cell quality of a serving cell being below a threshold, a measured cell quality of a neighboring cell being above a threshold, or a measured cell quality of the serving cell below less than a measured cell quality of a neighboring cell by a threshold amount.

The condition associated with the predicted RRM measurements comprises a predicted cell quality of a serving cell being below a threshold, a predicted cell quality of a neighboring cell being above a threshold, or a predicted cell quality of the serving cell below less than a predicted cell quality of a neighboring cell by a threshold amount.

The indication of radio resource management (RRM) measurement prediction capabilities comprises an indication of one or more frequencies supported by the WTRU, an indication of one or more cells that can be predicted by the WTRU, or an indication of a beam prediction type supported by the WTRU.

The RRM measurement report comprises a number of predicted RRM measurement samples and an indication of that the predicted RRM measurement samples are predicted RRM measurement samples.

The RRM measurement report comprises a number of predicted RRM measurement samples that have the highest cell quality, a mean or median of a plurality of predicted RRM measurement samples associated with a prediction time window, or an indication of a range of a plurality of predicted RRM measurement samples.

The first RRM measurement is associated with a first cell or first beam and is associated with a first time instance, and the second predicted RRM measurement is associated with a second cell or second beam and is associated with a second time instance.

The information to include in the RRM measurement report comprises an indication of a reporting periodicity for the RRM measurements or the predicted RRM measurements, an indication of a number of the predicted RRM measurements to include in the RRM measurement report, or a condition that triggers the WTRU to skip the sending of the RRM measurement report.

The first RRM measurement is determined for a first cell or beam and the second predicted RRM measurement is determined for a second cell or beam based on the first RRM measurement of the first cell or beam. The WTRU is configured to send a request for a measurement configuration for the first cell or beam, receive reference signals (RSs) associated with the first cell or beam, and determine the first RRM measurement for the first cell or beam based on the RSs.

The configuration information comprises information regarding triggering of an RRM measurement report, wherein the information regarding triggering of the RRM report comprises a reporting periodicity and whether to skip the sending of the RRM measurement report.

A method performed by a wireless transmit receive unit (WTRU). The method comprises sending an indication of radio resource management (RRM) measurement prediction capabilities of the WTRU to a network, and receiving configuration information, wherein the configuration information comprises information relating to RRM measurements or predicted RRM measurements, wherein the configuration information comprises a condition associated with the RRM measurements, and wherein the configuration information comprises information to be included in an RRM measurement report. The method comprises determining a first predicted RRM measurement and determining that a first RRM measurement fulfills the condition associated with the RRM measurements. A second predicted RRM measurement is determined based on the first RRM measurement fulfilling the condition associated with the RRM measurements, wherein the second RRM measurement is associated with a different cell, a different frequency, or a different time than the first RRM measurement. The RRM measurement report is sent to the network, wherein the RRM measurement report comprises information associated with the second predicted RRM measurement.

The configuration information comprises a condition associated with the RRM measurements. The method further comprises determining that the first RRM measurement fulfills the condition associated with the RRM measurements, and determining a second predicted RRM measurement based on the first RRM measurement, wherein the second predicted RRM measurement is associated with a different cell, a different frequency, or a different time than the first RRM measurement, and wherein the RRM measurement report comprises information associated with the second predicted RRM measurement.

In examples described herein, a WTRU may be configured with measurements to be performed and measurements to be predicted, and/or the inter-relationship between the two (e.g., measurements performed based on predictions and/or predictions performed based on measurements). The WTRU may inform the network about needed configurations for performing predictions. The WTRU may be configured with conditions when to perform the predictions or/and measurements (e.g., measured serving/neighbor cell signal level thresholds or trends, predicted serving/neighbor cell signal levels or trends, time durations, and/or locations/areas) The WTRU may be provided with predicted measurement reporting configurations (e.g., periodicities, a number of predicted samples to include in the reports, and/or a type of predicted measurement quantities to include). The WTRU may be configured with conditions to skip measurement reports (e.g., configured to skip a report if current measurements are not different from previously sent measurement predictions for the current time by more than a certain threshold).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example high-level view of a New Radio (NR) measurement model.

### DETAILED DESCRIPTION

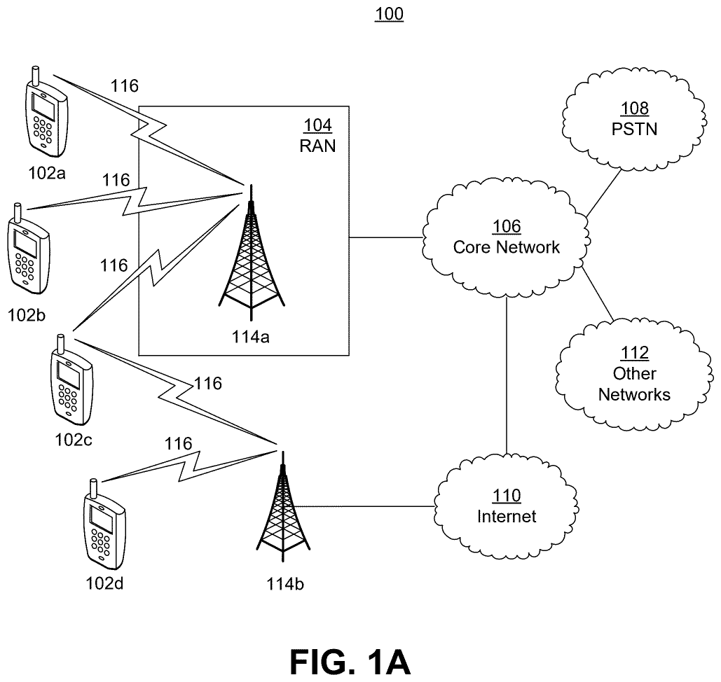

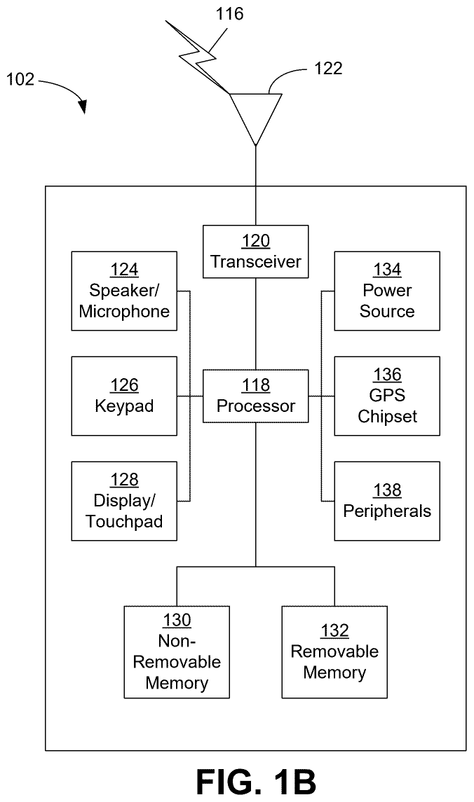

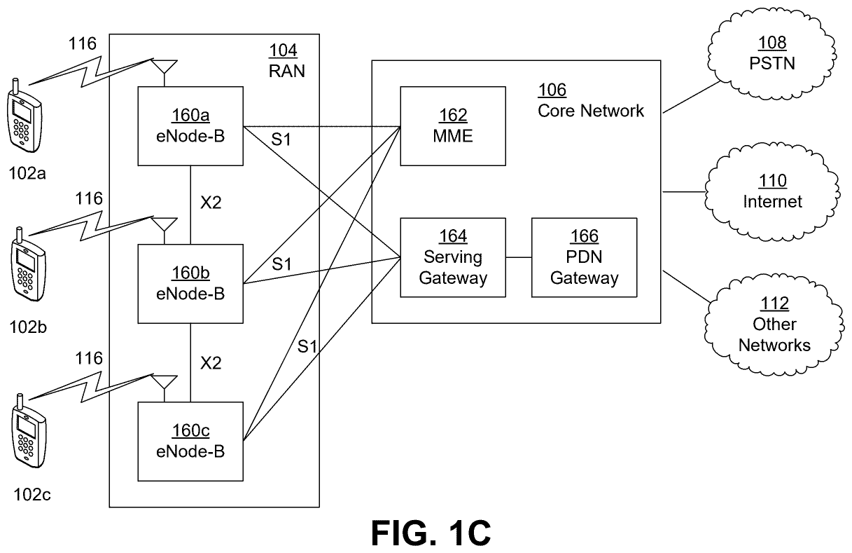

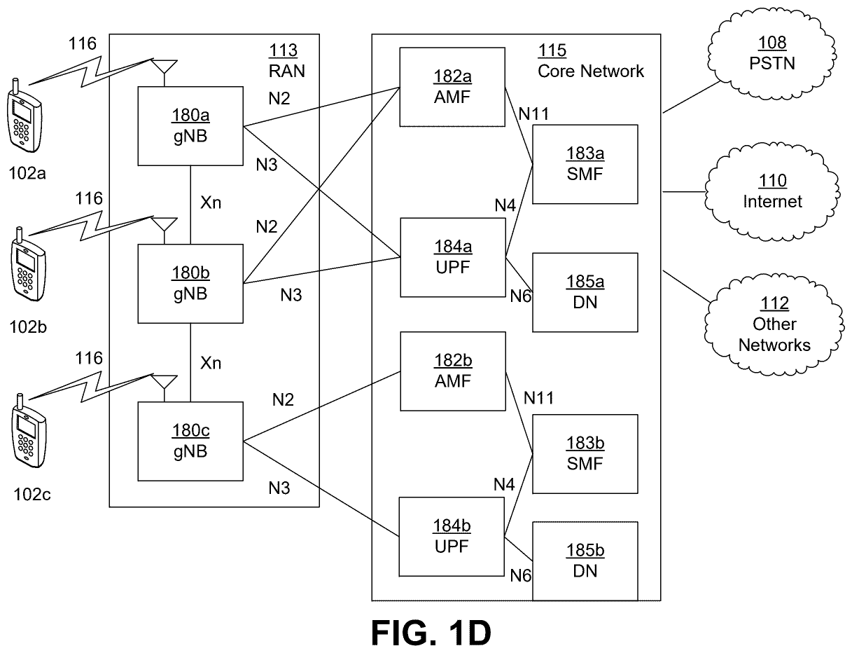

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

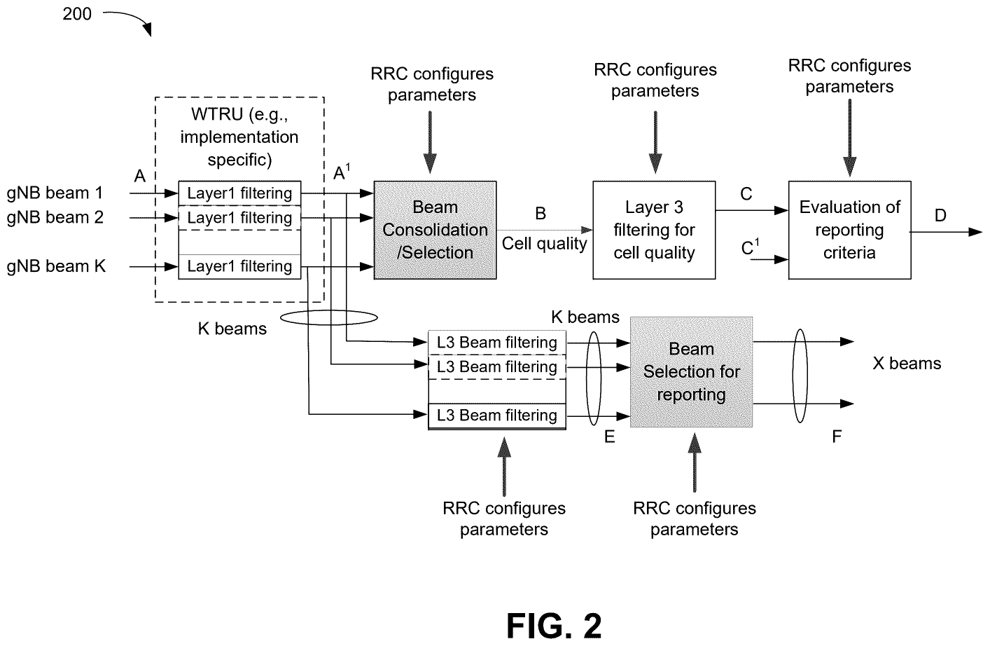

FIG. 2 is a diagram 200 illustrating an example high-level view of a New Radio (NR) measurement model. A WTRU may perform measurements of serving cells and/or neighbor cells based on a configuration received by the gNB. The WTRU may be configured to report the measurements periodically and/or when certain events are fulfilled (e.g., An A3 event, in which a neighbor cell's signal quality becomes better than the serving cell's signal quality by more than a certain threshold). The WTRU may be configured with a conditional handover (CHO) configuration regarding a certain neighbor cell, which may include a handover (HO) command and/or an associated measurement event. When the measurement event conditions are determined to have been fulfilled, the WTRU may execute the HO command associated with the event instead of, or in addition to, sending a measurement report.

The WTRU may receive a configuration (e.g., configuration information) from the gNB. The configuration information may include RRM measurement configuration information. The RRM measurement configuration information may include one or more of measurement objects, reporting configurations, and/or measurement IDs. The measurement objects may indicate what is to be measured (e.g., frequency, cells, Synchronization Signal Block/Channel State Information-Reference Signal (SSB/CSI-RS) configuration, offsets, measured quantities, and/or cell level measurement derivation parameters). The reporting configurations may indicate what is to be reported and/or when it is to be reported (e.g., specifying periodicity, event thresholds, time-to-trigger (TTT), hysteresis, and/or CHO configuration). Measurement IDs may indicate an association of a measurement object with a reporting configuration. For example, a reporting configuration may indicate that if there is no measurement ID associated with a measurement object, the measurement may not be performed.

An existing conditional reconfiguration (e.g., CHO) may include a target configuration coupled to a measurement event. The target configuration coupled to the measurement event may include target configuration information. The target configuration information may indicate that the WTRU may execute a reconfiguration (e.g., handover) when associated measurement criteria is met.

L1/2 triggered mobility (LTM) may include procedures in which a gNB may receive L1 measurement reports from a WTRU. The gNB may change the WTRU serving cell by a cell switch command signaled via a Medium Access Control (MAC) Control Element (CE). The cell switch command may indicate an LTM candidate configuration that the gNB previously prepared and provided to the WTRU through RRC signaling. The WTRU may switch to the target configuration according to the cell switch command. The LTM procedure may be used to reduce the mobility latency and handover interruption time.

L3-based handovers may be triggered by the network based on information received by the WTRU (e.g., measurement reports).

In RRM measurement prediction, three use cases may be identified. The first case (Case 1) may involve predicting beam level results and then generating cell level results based on the predicted beam results. The second case (Case 2) may involve directly predicting cell level results based on existing cell level results. The third case (Case 3) may involve directly predicting cell level results based on beam level results.

A WTRU may be configured by the network to identify what measurements to perform, when to perform the measurements, when to trigger measurement reports, and/or what to include in the reports. If a WTRU supports RRM-based measurement prediction, the WTRU may need further configuration information. The further configuration information may include information indicating how and/or when the WTRU performs the measurement predictions. The further configuration information may include information indicating an interaction between performing actual measurements and measurement predictions. The further configuration information may include an indication of how the reporting of the actual measurements and the measurement predictions is to be performed.

Specifically, the configurations (e.g., configuration information) received by the WTRU may enable the WTRU to determine at least one of the following: what is to be predicted (e.g., cells and/or frequencies); when to start or stop performing predictions and/or measurements; interactions between the predictions and the actual measurements (e.g., how to avoid performing unnecessary/redundant measurements and/or predictions); when to send prediction results and/or measurement results/reports; and/or what content to include in the reports.

The WTRU may be configured with interrelated configurations for performing RRM measurements, measurement predictions, and associated reporting of measurement predictions and actual measurements in an efficient manner. The examples described herein may include configuring a WTRU to perform RRM measurements and/or measurement predictions based on received WTRU configuration information. The received WTRU configuration information may include information specifying an interaction between performing the actual measurements and measurement predictions and/or specifying conditions for reporting of actual and/or predicted measurements.

The WTRU may perform one or more steps to determine RRM measurements and/or measurement predictions. The WTRU may send its RRM measurement prediction capability (e.g., frequencies and/or cells that can be predicted, a time of day and/or locations where predictions can be made, prediction windows, and/or confidence levels). The WTRU may receive a measurement configuration that includes one or more of the following: measurements to be performed (e.g., frequencies/cells and/or quantities to be measured); measurements to be predicted (e.g., frequencies/cells, quantities to be predicted, and/or prediction window(s)); and/or conditions when to perform the predictions and/or measurements (e.g., measured serving/neighbor cell signal level thresholds or trends, predicted serving/neighbor cell signal levels or trends, time durations, and/or locations/areas). The WTRU may receive a measurements/predictions reporting configuration. The measurements and/or predictions reporting configuration may include periodicities (e.g., same or different periodicities for measured and predicted reporting). The measurements and/or predictions reporting configuration may specify a number of predicted samples to include (e.g., fixed number, variable number depending on conditions such as confidence level or differences between the predicted samples). The measurements and/or predictions reporting configuration may specify conditions for skipping reports (e.g., skip a report if measurements now are not different from previously sent predictions for the current time by more than a certain threshold). The measurement and/or predictions reporting configuration may indicate what to include in the report (e.g., individual measurements/predictions, average/filtered values, and/or variations/deviations).

The WTRU may perform the measurements and/or predictions according to the configuration. The WTRU may send an indication to the network (e.g., an indication used by the network to start sending required RSs for the WTRU to do the predictions and/or an indication used to configure required resources/grants for the WTRU to send the reports). The WTRU may monitor the reporting conditions and when they are fulfilled, it may prepare the measurements report. The measurement report may include additional information such as the number of samples included, if a variable number of samples can be sent. The measurement report may be the same or different for measurements and predictions. The WTRU may send the measurement report(s). The measurement report can be a short message (e.g., UCI/MAC CE indicating measurements have not changed, and/or not predicted to be changed with a given observation window).

As used herein, the terms Al/ML and AIML may be used interchangeably. The terms “data,” “measurements,” “report,” and “results” may be used interchangeably. The terms “starting conditions” and “validity conditions” may be used interchangeably. The terms “indication”, “information”, and “message” may be used interchangeably. The terms “serving cell” and “source cell” may be used interchangeably. The terms “target cell” and “candidate cell” may be used interchangeably. The term Ax may be used to refer to any of the events A1, A2, A3, A4, A5, A6, where the events may be defined as follows: Event A1 (e.g., Serving becomes better than threshold); Event A2 (e.g., Serving becomes worse than threshold); Event A3 (e.g., Neighbor becomes offset better than SpCell, where SpCell may be the Primary Cell, PCell, or the Primary Secondary Cell, PSCell, in the case of dual connectivity); Event A4 (e.g., Neighbor becomes better than threshold); Event A5 (e.g., SpCell becomes worse than threshold1 and neighbor becomes better than threshold2); Event A6 (e.g., Neighbor becomes offset better than SCell, where an SCell may be a Secondary Cell in the case of carrier aggregation). The term Bx may refer to any of the events B1, B2, where the events may be defined as follows: Event B1 (e.g., Inter RAT neighbor becomes better than threshold); Event B2 (e.g., PCell becomes worse than threshold1 and inter RAT neighbor becomes better than threshold2).

It is noted that examples and descriptions provided herein focus generally on descriptions of measurement predictions based on AIML models, but it is to be appreciated that the examples and/or descriptions provided herein apply equally to any other form of prediction that doesn't use AIML (e.g., time series forecasting and/or interpolation methods). The solutions described herein may be agnostic to the kind of AIML model/technique used by the WTRU (e.g., the algorithm used, the mechanism such as a neural network or what kind of neural network, e.g., depth and/or parameters/weights of the network), the origins of the model (e.g., WTRU vendor, operator, and/or network vendor), or how/where the training of the model is done (e.g., the input data used for the training, where the training may be performed, and/or if the training is performed offline or online). However, one may assume that the model is trained based on historical observation of one or more WTRUs' actual measurements in different WTRU and/or network conditions (e.g., during certain time durations of the day, during certain days of the week, at different locations, different WTRU mobility patterns/speeds, under different network conditions that may be visible to the WTRU such as frequency/bandwidth, under different network configurations, which may be visible to the WTRU just as a network configuration index that is provided by the network at the time of training and/or data collection for the training).

The following assumptions may apply: some WTRU capability communication may occur between the WTRU and the network about AIML capability (e.g., where the WTRU indicates to the network the supported AIML models/functions, confidence level of predictions, and/or time horizon of predictions such as how far along in the future are the predictions being made). The WTRU may support several AIML models for a certain functionality (e.g., with different prediction time horizons, prediction confidence levels, processing requirements, trained under/for operation in different frequencies, cells, location, and/or times of day). A given AIML model may operate in different modes (e.g., with different levels of prediction confidence levels at different prediction time horizons, at different locations, frequencies, and/or WTRU mobility patterns/speeds). The WTRU may choose the AIML model to use for a certain functionality (e.g., network decides for which functionalities the WTRU may use AIML-based operation, and the WTRU chooses the AIML model to use) or the network may explicitly control this (e.g., WTRU provides details of AIML models and their capabilities, network determines which model to activate for a particular functionality). The AIML models may be available at the WTRU already trained, or the WTRU may be provided with an untrained AIML model and performs the training by itself. The AIML model may be available at the WTRU already trained, and the WTRU may be enabled/configured to perform further training (e.g., for different conditions such as frequencies/cells/location/times of day, for the same conditions as the initial training except for increasing the level of confidence and/or the prediction time horizon, and/or for different WTRU speeds). The AIML model may be available at the WTRU but not trained at all or only trained for certain WTRU/network conditions, and the WTRU may be configured to train the model (e.g., for the conditions that it is not trained for).

The WTRU may require some configurations/inputs that it needs for performing the inference using an AIML model. For example, for beam management prediction, the WTRU may need to be configured with a certain number of beams to measure to measure other beams (e.g., this may be referred to as set A/B configuration). In some cases, the WTRU may communicate the required configuration/input as part of the capability information. In other cases, the required configuration/input may be communicated to the network after a capability request (e.g., based on explicit network request, if the WTRU is configured to do AIML-based operations and it has determined that it is lacking the required configuration/input).

A given AIML functionality may be associated with a set of KPI (Key Performance Indicators) or metrics. For example, this could be prediction accuracy, average or mean square difference between measured and predicted values (e.g., for the beam prediction, these could be the beam prediction accuracy or/and confidence level, and/or a L1 RSRP difference between the measured and predicted beam signal levels). A WTRU may have one or more AIML models for a given functionality, and each may have performance levels that meet different KPI thresholds (e.g., WTRU may have two models, where one has an accuracy level of, for example, 90% and another one with an accuracy level of 95%). The WTRU may inform the network during its capability reporting or after the capability reporting.

A given AIML model may be trained under certain WTRU and/or network conditions. For example, a WTRU condition could be the speed of the WTRU. On the other hand, network conditions could be something that may be related to some network configurations/settings that the WTRU may not be aware of but may impact the performance of the model. For example, an AIML beam management model may perform differently if it is trained when the network was using a certain antenna pattern, beam pattern, power levels, and so on. Also, there could be aspects related to network load that may have an impact on the model performance. Since the WTRU doesn't necessarily need to know all these (e.g., and the network may also not want to expose some of these implementations), the network could hide these details by signaling to the WTRU a network configuration index or associated ID. For example, when data is being collected for training a model, tagging may be performed indicating under which network conditions the model is being trained. When a WTRU is being configured to perform an AIML operation, it may be configured to check the consistency between the conditions under which the AIML model is trained on and current conditions (e.g., current WTRU conditions, and or a current associated ID signaled by the network indicating current network conditions/settings).

It is noted that a focus of this disclosure may not be on the Life Cycle Management (LCM) of the beam/cell measurement prediction models/functionality. That is, one may assume that the WTRU is using a certain model for beam prediction that has been trained and performance tested for the current WTRU and/or network conditions. However, some of the solutions may enable some LCM aspects. For example, the measurement results the WTRU provides that contain actual measurements and predicted measurements, according to any of the solutions described below, may be collected and used for performance monitoring or model retraining. In another example, the WTRU may also be configured to do actual measurements of some of the cells/beams in parallel with using the AIML model to predict the beams/cells (in temporal or spatial manner), compare the actual measurements and the predicted ones, and decide to switch from one model to another, and so on, based on this comparison.

In an example, the WTRU may indicate that it is capable of beam level predictions and can perform the cell level RRM measurement predictions based on these beam level predictions. This may be referred to as indirect predictions henceforth. The WTRU's capability indication regarding beam level measurements may include one or more of the following: a beam prediction type, which may include one or more of the following: temporal prediction (e.g., prediction of the signal level of a beam at a future time instance based on, for example, current and historical signal levels of the beam); spatial prediction (e.g., prediction of the signal level of one beam based on the signal level of another beam, a beam of the same cell, and/or a beam of a different cell); a number of beams that can be predicted; a number of beams that need to be measured to do the predictions; a confidence level of the predictions; frequencies that can be predicted; cells that can be predicted; conditions under which the AIML functionality/models can operate (e.g., the models/functionality were trained under the indicated conditions, where the performance of the models/functionality has been tested and shown to work properly), where the conditions could contain WTRU and/or Network conditions (e.g., WTRU mobility state, WTRU location, cells/frequencies, time of day, and/or a network configuration index such as associated ID).

The WTRU may indicate that it can predict cell level measurements directly (i.e., the output of the AIML model is a cell level measurement). This may be referred to as direct predictions henceforth. The capability information for direct predictions may contain similar information like the beam level predictions (e.g., temporal vs spatial, number of cells that can be predicted, the cells/frequencies that can be predicted, confidence level of predictions, input/configuration required to do the predictions, and/or WTRU/network conditions for predictions). A WTRU may be capable of performing both direct and/or indirect predictions (e.g., direct prediction for certain cells/frequencies, indirect predictions for other cells/frequencies, direct predictions for certain locations, and/or indirect predictions for other locations). The WTRU may indicate to the network capability related to time domain prediction such as observation window and/or prediction window sizes (e.g., WTRU informing that the model is trained to use measurements observed within the prediction window duration, and maybe earlier measurements before that, to predict measurements for the next prediction window duration).

The WTRU may provide multiple observation window and prediction window combinations, each associated with different KPI thresholds (e.g., different accuracy levels, and/or different L1 RSRP difference levels between predictions and measurements). In one example, the observation/prediction window capability may be the same for all measurements (e.g., all cells and/or frequencies). In another example, the WTRU may have different observation/prediction window capabilities for different measurements (e.g., cells and/or frequencies). The WTRU may support the same observation/prediction window sizes for all measurements, but it may have different KPI thresholds for the different measurements (e.g., observation window size of x and prediction window size of y supported for predicting a cell at frequency fa and frequency fb, but the prediction accuracy for fa during that prediction window is level1 while for that of fb is level 2).

The observation and prediction window sizes may be specified in time durations (e.g., observation window=x ms, prediction window=y ms). In another solution, the observation and prediction window sizes may be specified in number of measurement samples (e.g., observation window=10 samples, prediction window=5 samples). The KPIs within the prediction window may vary from sample to sample within the prediction window. For example, assume the prediction window equals 10 samples, then the prediction accuracy for the first two samples can be of level 1, for the next three samples could be of level 2, and so on. The same differentiation can be applied for sub-time duration within the prediction window, if the prediction window is specified in time durations instead of the number of measurement samples. The capability may be provided at a functionality level (e.g.,, WTRU not explicitly indicating the number/identity of the models it is using, but simply providing the overall capability of the one or more models for the beam prediction capability) or it can be model level (e.g.,, WTRU providing explicit information about each model it has for the beam prediction functionality and associated capability information for each model).

The capability information may be provided autonomously by the WTRU (e.g., upon connection setup/resume, upon handover, and/or upon detecting that the WTRU has entered a new cell/region/RAT where the capability regarding beam prediction is different from previously reported capability) or based on an explicit request from the network. If capability information is requested from the network, the request may be a generic request (e.g., in which case WTRU may provide all its capabilities) or it can be a more granular request. For example, the WTRU may receive a request from the network, it supports beam prediction at a certain frequency layer, and the WTRU may respond with an indication that it doesn't support that or an indication that it supports that or/and detailed information about the capability regarding prediction of beam at the frequency layer (e.g., summarized information at functionality level, and/or detailed information for each AIML model that supported beam prediction at that frequency layer).

The WTRU may be configured on how to derive cell level measurements from predicted beams or a combination of predicted and actual beams. For example, assume the WTRU measures n1 beams of a cell and predicts n2 beams of the cell. To derive the cell level measurements, the WTRU may be configured with one or more of the following parameters that tell it how to do this determination: the beam consolidation threshold (e.g., RSRP threshold) for a beam to be considered for cell level measurement derivation. This threshold may be the same for actual measured beams and predicted beams, or it could be different (e.g., if different, the values may be independent or dependent on each other, e.g., the threshold for predicted beams being configured to be a scaled up/down value of the threshold for the actual beams). The number of beams to be considered/averaged in the cell measurement derivation. In one example, this could be a total number, regardless of the beams being predicted or measured (e.g., WTRU configured with n=n_total, and considers n_total beams with the highest RSRP in the beam consolidation, where the beams may be actual measured or predicted, if they have RSRP above the corresponding beam consolidation threshold). In another example, the WTRU may be configured to consider a certain number of predicted beams (n_total_predicted) and a certain number of measured beams (n_total_measured) in the cell level measurement derivation, if they fulfill the corresponding beam consolidation threshold. Once the average for the predicted ones is calculated out of the predicted ones and measured one, the two values may be combined equally (e.g.,, average of the two) or a weighted averaging is performed (e.g., measured beams have double the weight of the predicted one, e.g.,, cell level measurement=(2*average of measured beams+average of predicted beams)/3).

In a situation where the WTRU is executing temporal prediction of a certain cell (e.g., measure the beams of a given cell during T1 observation window, then predict them during T2 observation window, and so on), different filtering weights may be specified for considering values that are predicted and measured. For example, more weight may be given to measured values than predicted values (e.g., or vice versa). In all the above configurations, the different parameters may depend on the accuracy/confidence level of the predictions (e.g., more predicted beams considered in the beam consolidation for higher confidence level predictions, and/or larger filtering weight values given to predicted beams when the confidence level is higher). The WTRU may be configured with scaling factors or a mapping of different prediction accuracy/confidence levels and the different filtering/averaging weights and number of predicted beams to be considered.

In an example, to derive cell level measurement, a legacy WTRU may be configured with several parameters such as beam consolidation thresholds, number of beams to consolidate, and/or filtering parameters. In one solution, when a WTRU communicates capability for direct RRM measurement prediction, the WTRU may indicate to the network the value of one or more of the parameters that were used in the training of the model. During model training, the model output may be compared with the actual value at that time (e.g., which may be referred to as ground truth herein below). This ground truth may be the actual cell level measurement derived from actual measured beams using the cell level derivation and filtering parameters.

The WTRU may indicate to the network that it has the capability to do direct RRM measurement prediction for different cell level measurement derivation parameters. For example, the WTRU may indicate that it can do direct RRM measurement prediction for parameter set 1, 2, . . . n, where each parameter set indicates a set of values (e.g., or range of values) for the different parameters such as beam consolidation thresholds, number of beams to be consolidated, and/or filtering coefficients. The WTRU may indicate different characteristics for the models for the different parameter sets (e.g., model trained for parameter set 1 may have different confidence levels than model trained for parameter 2). In one solution, the WTRU may have different/separate models for the different parameter sets. In another solution, the WTRU may have one model that can take the parameter values as an input to the model. The WTRU may receive a configuration from the network indicating the parameter set to be used for the direct cell level prediction. For example, if the WTRU has separate models trained for the different parameter sets, it may use the model that corresponds to the indicated parameter set. In another example, if the parameter set were input variables to one model, the WTRU may use those input values for that model when starting to perform the cell level measurement inference.

In an example, the WTRU may receive a configuration from the network indicating a parameter set and it may not have a model that perfectly matches the indicated parameters. In that case, the WTRU may be configured to use the model that is trained with the parameter set that is the closest from the indicated parameter set. For example, if the WTRU has two models, one trained for the maximum number of beams for beam consolidation equal to 3 and the other one trained for beams to be consolidated to be equal to 6, and the indicated parameter from the network was 5, the WTRU may choose to use the later model.

The WTRU may have the capability to perform both direct and/or indirect predictions for a certain frequency and/or cell. In that case, the decision to use one or the other may be based on explicit configuration from the network or based on some WTRU decision (e.g., by looking at the required beam consolidation thresholds, number of beams to be consolidated, and/or filtering parameters. The WTRU may determine whether it has a direct AIML model that can do the direct predictions, and if so, uses it, otherwise, it may resort to doing indirect predictions by performing the beam level predictions and deriving the cell level measurement from the direct predictions).

The WTRU may be able to translate prediction results from a model trained for certain cell measurement derivation parameters into another one and communicates this information to the network, and the network may configure it to do such translation of prediction results. For example, if a model was trained for cell measurement derivation parameter set 1, the network may configure the WTRU to do the derivation using parameter set 2. The WTRU may do the prediction using the model trained for parameter set 1 but may translate/transform the prediction results before sending the measurements to the network.

As described in further detail above, a legacy NR measurement configuration may comprise any combination of the following: Measurement objects, such as what is to be measured (e.g., frequency, cells, SSB/CSI-RS config, offsets, measured quantities, and/or cell level measurement derivation parameters); Reporting configurations, such as what is to be reported and/or when it is to be reported (e.g., periodicity, event thresholds, TTT, hysteresis, and/or CHO config); and/or Measurement IDs, such as an association of a measurement object with a reporting configuration (e.g., if there is no Meas ID with a measurement object, that measurement may not be performed).

In an example, a new information element (IE) may be defined for configuring measurement objects for predictions and/or additional IEs may be added to the current measurement object configuration IE to include the new parameters related to predictions. This measurement object configuration may include all or a subset of the current configuration for performing actual measurements, and/or any additional IEs that are required for performing measurement predictions. For example, this may include an indication for whether the WTRU uses direct and/or indirect predictions for this measurement object; parameters related to cell level measurement derivation and filtering be used for converting beam level measurements to cell level measurement for indirect predictions and/or to choose the proper model for the case of direct predictions, as discussed above. This measurement object configuration can include beam consolidation thresholds for predicted beams and/or measured beams, a number of predicted/measured beams that can be consolidated in the cell level measurement derivation. This measurement object configuration can include filtering parameters while averaging samples that contain some actual measurements and some predictions (e.g., the weighting ratio between predicted samples and measured samples); In case of spatial beam predictions, the beams that are to be measured and the beams that can be predicted; In case of temporal predictions, the duration for the observation and prediction windows (e.g., measure for x ms, then predict for the next y ms).

In an example, a measurement object (e.g., configuration) for actual measurements and predicted measurements may be the same (e.g., for a given frequency), but separate measurement object configurations may be provided for predictions related to different cells at that frequency level (e.g., the common IEs that may apply to both predictions and actual measurements are provided in the legacy measurement object configuration that is applicable to all measurements at that frequency layer, configuration 1 can contain prediction-related configurations for cell 1, configuration 2 can contain prediction-related configurations for cell 2, and so on). In some cases, for a given cell, there could be actual measurement and prediction configurations (e.g., the WTRU is measuring the current cell, but prediction measurements refer to temporal predictions). In some cases, for a given cell, there could be only prediction-related configurations (e.g., the WTRU will not be measuring the cell at all, but predicting the signal levels of that cell now, e.g.,, spatial prediction, and/or also temporally, e.g.,, future durations).

In some examples, the above-described configuration for the prediction may be implicit. For example, the WTRU may have communicated to the network the detailed capabilities of the AIML models that it has, and the network may just indicate which AIML model the WTRU needs to use for a given measurement object. In other examples, the above configuration may be explicit, and the WTRU may determine the appropriate model for that configuration. In the case of the configuration being explicit, if the WTRU determines that it has no AIML model that will be able to do the predictions according to the received prediction configuration, it may respond to the network indicating that it is not able to do the predictions (e.g., in an RRC reconfiguration complete message as a response to the measurement prediction configuration, including a cause value for the failure to do the predictions). Alternatively, or additionally, the WTRU may consider this as an error (e.g., Radio link failure) and may trigger a recovery procedure such as an RRC re-establishment (e.g., with a cause value indicating invalid prediction configuration).

The WTRU may not have communicated all the details of the AIML models and/or functionalities it has to the network, and once the network has configured it for measurement prediction (e.g., by explicitly configuring at least some of the parameters above), the WTRU may respond to the network with information about the details of the predictions that it is going to perform (e.g., the prediction KPIs such as accuracy levels, observation/prediction window, number of cells that can be predicted, particular cells that can be predicted, and/or additional configurations the WTRU may need to do the predictions).

The WTRU may provide information to the network regarding the cells and/or frequencies that it can predict. This information further may include additional information (e.g., in addition to the detailed capability-related information discussed above, such as confidence levels, and/or observation/prediction window sizes), which may include the inputs required for the WTRU's AIML model to make the inference. For example, this could be a relationship between the cell/frequency to be predicted and cells/frequencies being measured. For example, the WTRU may inform the network that it needs to have actual cell/beam level measurements of cell y and z to predict measurements of cell x. For example, the WTRU may provide a set of such lists, including the cells/frequencies to be predicted and the corresponding cells/frequencies to be measured and used as input to do these predictions.

The WTRU may provide additional information that may relate to needed configurations to perform certain predictions. For example, if indirect predictions are to be made from beam level predictions, the WTRU may indicate the required Set A/B configurations required for that prediction. The WTRU may indicate high-level information in the WTRU capability (e.g., cells, frequencies that can be predicted), and it may provide further information on the required measurements or configurations for doing the predictions on further request from the network. This request could be an implicit or explicit request. The explicit request could be the network asking the WTRU if a particular measurement prediction (e.g., of a given cell and/or frequency) that the WTRU has indicated to be capable of performing can be performed now. The WTRU may just respond with a “yes/no”, or if it is a “no”, it can indicate the additional measurements that the WTRU needs to do the predictions (e.g., indicating predictions of the measurements of cell x cannot be current because WTRU is not detecting one of the cells (e.g., cell y, that is needed to be used as an input to the AIML model, and cell Y can be detected but the signal level is not within the required range at which the model was trained).

In an example, the explicit request from the network may be regarding (all) the cells and/or frequencies that can be predicted by the WTRU now, and WTRU indicating the cells and/or frequencies that can be predicted at the moment. The response from the WTRU regarding an explicit request could be just an indication of support or non-support (e.g., 0 indicating not supporting and 1 indicating support, or a bitmap in case the request concerned multiple cells and/or frequencies, each bit corresponding to the indicated cell and/or frequency in the request) or it may include detailed information such as capabilities for the prediction such as accuracy levels/confidence levels, prediction/observation window sizes (e.g., for each cell and/or frequency indicated in the request). The implicit request could be the network opportunistically configuring the WTRU to do a particular measurement prediction without knowing all the inputs/configurations required by the WTRU for performing the predictions. If the WTRU has all the inputs/configurations it needs to do the predictions, it may send a confirmation and immediately start performing the predictions. However, if sending a confirmation and immediately starting to perform the predictions is not possible at a certain time, the WTRU may send an indication that it cannot perform the predictions now and may include the reason why (e.g., the explicit request case described above).

The WTRU may provide all the detailed information of inter-dependency between required measurements/configurations and predictions in the WTRU capability information. The WTRU may provide information regarding the inter-dependency between required measurements/configurations and predictions upon executing a handover (e.g., in the handover complete message, in a separate message, and/or just an indication of such information availability in the handover complete message and providing the detailed information on further explicit request from the network). For example, the WTRU may inform the new serving cell that while in this cell, it can perform predictions of the following neighbor cells (x, y, z), etc. The WTRU may further indicate the relationship between the signal level range of the current serving cell and the predictions (e.g., a prediction of cell x and y is possible if the current serving cell signal level is between threshold1 and threshold2 and/or a prediction of cell z is possible if current serving cell signal level is between threshold3 and threshold4 and cell a is also being measured and having a signal level between threshold5 and threshold6).

The WTRU may provide information regarding the inter-dependency between required measurements/configurations and predictions upon executing an RRC connection setup or RRC connection resume. All the information may be included in the setup/resume complete message, or the WTRU may send an indication of information availability in the resume/setup complete message and detailed information upon further request from the network, or send the indication in the resume/setup request message and detailed information upon further request from the network.

The WTRU may be configured with conditions related to actual measurements that it monitors to determine whether it can start predictions for other measurements. The WTRU may be configured with thresholds (e.g., RSRP thresholds) of the serving cell and/or neighbor cells that it actually measures, and if these thresholds are fulfilled, the WTRU may be configured to start doing some measurement predictions. Some examples are given below: if the serving cell signal level goes below threshold1, start doing temporal measurement prediction of the same cell and/or start doing (spatial) measurement prediction of neighbor cells (e.g., all neighbor cells that the WTRU is not currently measuring or predicting, specific neighbor cells, and/or neighbor cells at a certain frequency layer), and/or start doing (temporal) measurement prediction of neighbor cells (e.g., all neighbor cells that the WTRU is currently measuring, specific neighbor cells, and/or neighbor cells at a certain frequency layer); if the measured neighbor cell signal level goes above threshold2, start doing temporal measurement prediction of that neighbor cell, and/or start doing temporal measurement prediction of the serving cell, and/or start doing temporal/spatial prediction of other neighbor cells (e.g., all neighbor cells the WTRU is currently measuring, all neighbor cells that the WTRU can predict/detect, specific neighbor cells, and/or neighbor cells at a certain frequency layer); if the serving cell signal level becomes lower than the measured neighbor cell signal level by more than threshold3, start doing temporal measurement prediction of the serving cell and/or the concerned neighbor cell, start doing temporal measurement prediction of other neighbor cells that the WTRU currently measuring, start doing prediction of other neighbor cells that the WTRU is not currently measuring.

The WTRU may be configured with thresholds (e.g., RSRP thresholds) of the predicted measurements of the serving cell and/or neighbor cells, and if these thresholds are fulfilled, the WTRU may be configured to start performing actual measurements. Some examples are given below: if the predicted serving cell signal level (e.g., at a certain prediction window in the future) goes below threshold1, start performing the measurements of neighbor cells (e.g., all neighbor cells that the WTRU is not currently measuring or predicting, specific neighbor cells, and/or neighbor cells at a certain frequency layer), and/or start performing (temporal) measurement prediction of neighbor cells (e.g., all neighbor cells that the WTRU is currently measuring, specific neighbor cells, and/or neighbor cells at a certain frequency layer); if the predicted neighbor cell signal level goes above threshold2, start performing measurements of that neighbor cell, and/or start performing temporal measurement prediction of the serving cell, and/or start performing temporal/spatial prediction of other neighbor cells (e.g., all neighbor cells the WTRU is currently measuring, all neighbor cells that the WTRU can predict/detect, specific neighbor cells, and/or neighbor cells at a certain frequency layer); if the predicted serving cell signal level becomes lower than the predicted neighbor cell signal level by more than threshold3, start performing measurements of that neighbor cell or other neighbor cells, start doing temporal measurement prediction of other neighbor cells that the WTRU is currently measuring, start doing prediction of other neighbor cells that the WTRU is not currently measuring.

A combination of the above may also be possible where a measurement to be performed (e.g., at a given cell and/or frequency) can be a function of some measurements and/or some predictions. The reverse may also be possible, where predictions are triggered based on some actual measurements and/or some predictions. It should be noted that the above may be just examples and by no means complete. In general, the inter-dependency between the actual measurements and predictions may be generalized as follows: measurement to be performed (e.g., for a certain frequency layer f1, and/or for a certain cell c1) may equal a Function (predicted measurements for frequency layer f2, and/or predicted measurements of cell c2); and/or a measurement to be predicted (e.g., for a certain frequency layer f1, for a certain cell c1) may equal a Function (measurements performed at frequency layer f2, and/or predicted measurements of cell c2). A combination of these is also feasible. For example, a measurement to be performed can be dependent on other measurements and predictions. In another example, a prediction to be performed can be dependent on other measurements and predictions. It is noted that in various solutions, f1 may be the same or different from f2; c1 may be the same or different from c2; f1, f2, c1, c2, etc. may refer to single values or a set/range of multiple values (e.g., f1=[fa, fb, fc], f2=[fd, fe], c1=[cell x, cell y], and/or c2=[cell z]); f1, f2 may refer to serving or neighbor frequencies; and/or c1, c2 may refer to serving or neighbor cells.

The WTRU may receive a separate measurement and reporting configuration for actual measurements and predictions. For example, the WTRU may be configured as follows. The WTRU may be configured with a first measurement object configuration, which for example, may be for actual measurements related to frequency x (e.g., or a specific cell or group of cells in that frequency layer). The WTRU may be configured with a second measurement object configuration, which for example, may be for measurement prediction related to frequency x (e.g., or a specific cell or group of cells in that frequency layer). The WTRU may be configured with a reporting configuration 1 and/or a reporting configuration 2 (e.g., which may be associated with the first and second measurement object configurations). The WTRU may be configured with a first measurement identification (ID1), which for example, may associate the first measurement object and the first reporting configuration. The WTRU may be configured with a second measurement identification (ID2), which for example, may associate the second measurement object and the second reporting configuration. The reporting configuration for predicted measurements may contain all the information that is currently configurable for actual measurements (e.g., periodicity and/or thresholds), but may contain additional parameters/IEs. In one solution, the reporting configuration for predicted measurements may contain information regarding the number of predicted samples to include in one prediction report. Alternatively, or additionally, this may be specified in terms of time duration.

The reporting configuration for predicted measurements may indicate to the WTRU if individual predicted samples and/or statistical information of these samples is to be included in the report. For example, the WTRU may be configured to include one or more of the following in the predicted measurement report. The predicted measurement report may include a certain number of predicted samples in the future. The predicted measurement report may include all the predicted samples within a given future time duration/window. The predicted measurement report may include the top n strongest predicted samples in the reporting/prediction time duration (e.g., the prediction window for the model being used). The predicted measurement report may include the bottom n predicted samples in the reporting/prediction time duration (e.g., the prediction window for the model being used). The predicted measurement report may include the mean and/or median of the samples in the reporting/prediction time duration. The predicted measurement report may include the range (e.g., maximum and minimum) of the samples. The predicted measurement report may include other statistical information (e.g., standard deviation, and/or a number/percentage of samples above/below a certain threshold). In one solution, the WTRU may receive a common measurement object configuration for actual measurements and predictions but separate reporting configurations for the two. The first measurement object configuration (e.g., measurement configuration 1) may apply to actual and predicted measurements related to frequency x (e.g., or a specific cell or group of cells in that frequency layer). The first reporting configuration (e.g., the first reporting configuration 1) and/or the second reporting configuration (e.g., the reporting configuration 2) may be associated with measurements related to a particular frequency, specific cell, and/or group of cells in the frequency layer. The first measurement ID may associate the first measurement object and the first reporting configuration, while the second measurement ID may associate the second measurement object and the second reporting configuration.

The reporting configuration may include the information (e.g., all the information) discussed above for the separate measurement object/reporting configuration but may additionally include the configuration related to performing the measurements as well (e.g., the configuration parameters discussed in the section on measurement configuration for RRM predictions above). In one solution, the WTRU may be provided with one common reporting configuration that includes configuration/parameters related to the reporting of actual measurements and parameters related to the reporting of predicted measurements (e.g., for all cells at a given frequency layer, and/or for a specific cell or group of cells).

A number of predicted samples to be included or the time duration window may be implicit (e.g., based on the indicated AIML capability of the RRM measurement prediction model) or it may be explicit. For example, the WTRU may have indicated it can predict for a time duration window of length T1, and the network may configure the WTRU to report the predictions for only a time duration of length T2, where T2<T1. In another example, the WTRU may have indicated that it can support T1 and T2 prediction time durations (e.g., with different accuracy levels), and the reporting configuration may indicate which time duration to be chosen by the WTRU during reporting. Similar configurations may be done for the reporting configuration that indicates the number of samples instead of time durations.

The WTRU may be configured to send predicted and actual measurement reports independently (e.g., each triggered independently with the periodic and/or event-triggered configuration associated with it). In one solution, the WTRU may be configured to send a measurement report that contains a combination of actual and predicted measurements. For example, the WTRU may include the actual measurements now and a certain number of samples of predicted measurements in the future (according to any of the solutions discussed above). In one measurement report, the WTRU may contain information such as the following: for cell a, only one measurement result may indicate the current signal level of cell a. For cell b, only one predicted measurement result may indicate the predicted signal level of cell b right now (e.g., if cell b is not measured at all and only predicted). For cell c, multiple results may include the first one indicating the measured signal level of cell c right now, and the rest indicating predicted future values. For cell d, multiple results may include the first one indicating the predicted signal level of cell d right now, and the rest indicating predicted future values.

In some examples, rather than multiple future values, as discussed above, a summarized/statistical information may be provided regarding predicted measurements (e.g., such as average values, ranges, and/or standard deviations). In one solution, whether the WTRU includes the individual predicted samples or the summarized/statistical values may be configured to depend on the predictions (e.g., include samples if there are more than a certain number/percentage of samples above/below a certain signal level threshold, include samples if the range of the predicted values is within/outside a certain range, and/or include the samples if the standard deviation of the samples is above a certain value).

The WTRU may be configured to include an indication regarding the number of predicted samples that are included or whether summarized/statistical information is included (e.g., if the WTRU was configured to vary the number of samples included according to any of the solutions above, for example, just include the average and standard deviation rather than multiple sample values). In one solution, the number of predicted samples to be included or the statistical/summarized information to be included may be the same at a measurement report level (e.g., all the reported cells will comprise the same number of predicted samples). Several alternative solutions to decide the number of samples or whether to use statistical information or not, as described in further detail herein below.

For example, if n cells were to be included in the measurement report, and for the majority of the cells, the predictions results were in such a way that individual samples were not required (e.g., most of the cells were showing stable radio conditions in the prediction window), the WTRU may be configured to include only statistical/summarized information for all the reported cells (i.e., even if there was one cell that was not showing stable conditions, only summarized/statistical information about this cell's predicted signal levels will be included in the report). On the other hand, if the majority of the cells were predicted to have unstable (or highly varying signal levels) within the prediction window that is being reported, individual predicted samples may be included in the report (e.g., even for the cells that were having stable conditions during the prediction window). Instead of or in addition to stability/variability conditions, the WTRU may be configured with actual signal level thresholds to make the decisions (e.g., include samples if there are a majority of neighbor cells that are predicted to have a signal level above x or have a signal level better than the source cell by more than y).

The WTRU may decide to include individual samples or statistical/summarized information (e.g., and the number of samples to be included in the former case) based only on the predicted results of the serving cell. For example, if the predicted results for the serving cell, according to any of the solutions above, mandate the sending of individual samples, WTRU may include individual predicted samples for the neighbor cells as well, regardless of the prediction results of the neighbor cells. Alternatively, the WTRU may include a summarized version of the neighbor cell results if it includes individual samples for the serving cell, or vice versa. Similar to the previous one, but the decision may be based on one or more of the neighbor cell's predicted signal levels within the prediction window, rather than the serving cell.

In an example, a number of predicted samples or the statistical/summarized information to be included in the measurement report may differ for the different cells included in the same measurement report. For example, the WTRU may include x number of samples for cell 1, y number of samples for cell 2, and only statistical information for cell 3, and so on (e.g., where the determination is done separately for each cell, according to the received configuration for performing these decisions, according to any of the solutions discussed above). In one solution, the WTRU may be configured with a relationship between the predicted measurement reports. The WTRU may be configured to trigger a report of certain actual measurement results based on prediction results (e.g., if the prediction of the serving cell indicates a signal level lower than a certain level within a certain prediction time window, the WTRU may trigger a report that contains actual measurement results of the serving cell and the neighbor cells the WTRU is measuring).

The WTRU may be configured to trigger a report of certain predicted measurement results based on actual measurements. For example, if the serving cell's signal level is measured to be below a certain indicating a signal level lower than a certain level within a certain prediction time window, the WTRU may trigger a report that includes actual measurement results of the serving cell and the neighbor cells the WTRU is measuring. The WTRU may be configured to skip sending actual measurement results if it has previously sent a predicted measurement report that is found to be correct (e.g., If all samples are predicted within a particular delta, then a sample may be included with a flag indicating that the samples are substantially the same for a particular (x) period of time). For example, assume the WTRU has sent a predicted measurement result at time t1, indicating the predicted measurement results at t1+delta, t1+2delta, . . . t1+ndelta. Assume the WTRU is also configured to send actual measurements at a periodicity of m*delta (e.g., m=2). At the next reporting interval, the WTRU will check the current measurements and find out that the previously predicted measurements at t1+delta and t2+delta were correct (e.g., the difference between actual and predicted values is lower than a certain configured threshold) and may refrain from sending the measurement report. Instead of comparing each individual value, the comparison could be based on comparing averages or some other statistical metric. For the previous example, the WTRU may average the two measured samples and also average the two previously reported predicted samples and compare the difference between the two average values to determine whether a measurement report should be sent or not.

In one solution, the WTRU's decision may be to send a measurement report but to include or not include the measurement results of a particular cell in the measurement report. For example, if the WTRU has previously sent a predicted measurement result of n cells, the determination to include the actual measurements of the individual cells may be performed separately (e.g., according to the solution described above) and the final report may be generated that includes results of only the cells where it has been determined to include the measurements. In one variant of this solution, the WTRU may include some indication regarding the cells that were not included in the measurement report (e.g., a list of these cells, and/or just one value that indicates previous predicted values are still valid corresponding to each cell's measurement entry).

The decision to send or not send a measurement report may be based on considering how the predicted measurements for the multiple cells compare to the current measurements of these cells. For example, if the WTRU has included predictions for cells 1 to n in the earlier measurement report, the WTRU may check how many of these measurements are now determined to be correct e.g., (according to any of the cells above), and if the majority of the predictions were correct, the WTRU may not send the measurement report (e.g., or it may send a simple indication, just indicating previous prediction reports were valid).

In another variant of the above example, instead of the decision based on the majority, the decision could be based on the measurements of the serving cell. For example, if the serving cell's predictions were accurate, the WTRU may refrain from sending the measurement report (e.g., or just indicates previous prediction reports were valid), even if there were one or more neighbor cells regarding which the predictions were not correct. Similarly, if the serving cell's predictions were determined to be not accurate, the WTRU may trigger the measurement and include measurement results of one or more neighbor cells, even if the predictions of these neighbor cells were determined to have been accurate. Alternatively, the validity/correctness of one or more neighbor cells may be used in the determination of whether a measurement report for actual measurement results should be sent or not, instead of the validity/correctness of the serving cell's measurement predictions.

The WTRU may be configured to send predicted measurement results for the next prediction window depending on the accuracy of the predictions in one or more previous prediction windows. For example, if the prediction of the previous window was determined to be valid/correct within the one or more previous windows, the WTRU may trigger the sending of the prediction for the next prediction window. The WTRU may be configured by the number of previous windows to consider determining the accuracy. Several examples of such configuration may be provided below. The WTRU may send the next prediction window results only if more than a certain number or percentage of the predictions in the previous n prediction windows were determined to be valid/correct, send the next prediction window results only if there were a certain number of consecutive prediction windows where the prediction was determined to be valid/correct, or send the next prediction window results only if there were not more than a certain number of consecutive prediction windows where the prediction was determined to be invalid/incorrect.

Note that this decision could be done per individual cell level or at a measurement report level, similar to the solutions discussed above. Also, if the WTRU has decided not to send a predicted measurement report (e.g., regarding a certain cell or the whole measurement altogether according to any of the solutions above), it may send an indication to the network regarding that (e.g., an empty report, a preconfigured indication value, and/or a measurement report that includes separate indication for the individual concerned cells).

In one solution, the WTRU may be pre-configured with a partition of the measurement IDs, where the first partition may relate to actual measurements and/or measurement reporting configurations, and the second partition may relate to predicted measurements and/or measurement reporting configurations. For example, the first partition may be configured to be measurement IDs 1 to n while the second partition is configured to be IDs n+1 to m. Thus, when the WTRU is being configured a configuration that associates a given measurement object with a reporting configuration and the ID belongs to the first partition, it will implicitly know that these configurations are related to actual measurements. On the other hand, if the ID belongs to the second partition, the WTRU will implicitly know that these configurations are related to actual measurements.

Alternatively, or additionally, instead of ID partitioning, the WTRU may be configured with additional information in the measurement ID configuration, individually indicating if that ID is related to actual measurements or predictions. A given measurement ID may be associated with both predictions and actual measurements (e.g., according to some of the solutions above). In the majority of solutions descriptions above, when thresholds were mentioned, one may assume that these thresholds were compared with current signal levels (e.g., or filtered signal levels). However, it is to be appreciated that all the solutions may be expanded to cover scenarios where the thresholds may relate to trends rather than actual values. For example, a threshold may be defined related to the rate of change (e.g., positive or negative) of a signal level over a certain duration.

The WTRU may be configured to include time stamps (e.g., SFN, actual time value, delta time value from previously agreed upon reference time and/or previously reported time) in the predicted measurement reports. In one solution, the WTRU may be configured to include location information (e.g., GNSS coordinates, and/or cell/RAN area information) in the predicted measurement report. In one solution, the measurement report may be an RRC message. In one solution, this RRC message may be a light/small message that includes just an indication if the predicted measurements are expected to be stable (e.g., where what constitutes stable may be pre-configured by the network). For example, it may refer to an indication that the previous predictions were correct. In another example, this may refer to an indication that the current measurement results are expected to be in the same range for the prediction duration, and so on. In one solution, the measurement report may be a MAC CE. In one solution, the measurement report may be a UCI indication. In an example, if the WTRU predicts a measurement for a future time and subsequently preforms an actual measurement at that future time, the WTRU may refrain from sending the actual measured result to the NW if the actual measured result is consistent with the predicted value. In this situation, the WTRU may send, for example, a flag indicating that the actual measurement aligns with the predicted value.

In response to being configured with one or more predicted measurement objects, a WTRU may transmit an indication including the real measurement configuration needed to best support the prediction. For example, a WTRU may be configured to predict a measurement on beam/cell/carrier A. The WTRU responds by indicating that a (e.g., real) measurement configuration for beams/cells/carriers B and C are needed. The network can then configure (e.g., real) measurements on B and C. This may be done by RRC configuration or more dynamically, e.g., WTRU requests using MAC CE a specific measurement resource to be configured, for example in the case of using CSI-RS WTRU can request gNB transmits specific CSI-RS to support prediction. The benefit may include avoiding excessive signaling overhead to signal all of the combinations, by only signaling what is needed to support the configuration and avoiding excessive measurement effort by configuring only what is determined to be needed.

In some examples, a selection of (e.g., real) measurement resources may be based on predicted future outcomes. A WTRU may select specific measurement objects or carrier/cell/beam resources to perform real measurements based on the predicted results on prediction-based objects. For example, a WTRU may be configured with predictions for cells C and D. The WTRU may detect that C becomes reasonably likely (e.g., or is configured to enable prediction for C), and for accurate prediction of cell C, real measurements of cells A and B are enabled to provide input for improving the prediction outcome. This may be semi-static, or perhaps more dynamic if the situation changes within a cell. The selection may be WTRU-based, or it may be a request/response from the network. The benefit may include that WTRU measurement capability may be limited (e.g., maximum number of carriers), and by using measurement prediction, WTRU may be configured with more measurements than simultaneously supported and select the most suitable based on prediction.

Selection of prediction-based measurement events/objects may be based on real measurement input. A prediction event may be enabled when certain real measurement criteria are met, for example, when the measurement of cells A and B are above a threshold, start cell C prediction. The benefit may include that prediction-based capability may be limited and/or processing requirements may be improved by performing prediction on the most likely and/or prioritized candidates based on the real measurement results.

1. A method performed by a wireless transmit receive unit (WTRU), the method comprising:
sending an indication of radio resource management (RRM) measurement prediction capabilities of the WTRU to a network;
receiving configuration information, wherein the configuration information comprises information relating to RRM measurements or predicted RRM measurements, wherein the configuration information comprises an indication of a condition associated with the RRM measurements, and wherein the configuration information comprises an indication of information to be included in an RRM measurement report;
determining a first predicted RRM measurement;
determining that a first RRM measurement fulfills the condition associated with the RRM measurements;
determining a second predicted RRM measurement based on the first RRM measurement fulfilling the condition associated with the RRM measurements, wherein the second predicted RRM measurement is associated with a cell that differs from a cell associated with the first RRM measurement, a frequency that differs from a frequency associated with the first RRM measurement, or a time that differs from a time associated with the first RRM measurement; and
sending the RRM measurement report to the network, wherein the RRM measurement report comprises information associated with the second predicted RRM measurement.

2. The method of claim 1, wherein the configuration information comprises an indication of a condition associated with the predicted RRM measurements, and wherein the method further comprises:
determining that the first predicted RRM measurement fulfills the condition associated with the predicted RRM measurements; and
determining a second RRM measurement based on the first predicted RRM measurement fulfilling the condition associated with the predicted RRM measurements, wherein the second RRM measurement is associated with a cell that differs from a cell associated with the first predicted RRM measurement, a frequency that differs from a frequency associated with the first predicted RRM measurement, or a time that differs from a time associated with the first predicted RRM measurement; and
wherein the RRM measurement report comprises information associated with the second RRM measurement.

3. The method of claim 1, wherein the second predicted RRM measurement is determined based on the first predicted RRM measurement.

4. The method of claim 1, wherein fulfillment of the condition associated with the RRM measurements comprises a measured cell quality of a serving cell being below a threshold, a measured cell quality of a neighboring cell being above a threshold, or a measured cell quality of the serving cell being less than a measured cell quality of a neighboring cell by a threshold amount.

5. The method of claim 2, wherein fulfillment of the condition associated with the predicted RRM measurements comprises a predicted cell quality of a serving cell being below a threshold, a predicted cell quality of a neighboring cell being above a threshold, or a predicted cell quality of the serving cell being less than a predicted cell quality of a neighboring cell by a threshold amount.

6. The method of claim 1, wherein the indication of RRM measurement prediction capabilities comprises an indication of one or more frequencies supported by the WTRU, an indication of one or more cells for which the WTRU can predict RRM measurements, or an indication of a beam prediction type supported by the WTRU.

7. The method of claim 1, wherein the RRM measurement report comprises a number of predicted RRM measurement samples and an indication that the predicted RRM measurement samples are predicted RRM measurement samples.

8. The method of claim 1, wherein the RRM measurement report comprises a number of predicted RRM measurement samples that have a highest cell quality, a mean or median of a plurality of predicted RRM measurement samples associated with a prediction time window, or an indication of a range of the plurality of predicted RRM measurement samples.

9. The method of claim 1, wherein the first RRM measurement is associated with a first cell or a first beam and is associated with a first time instance, and the second predicted RRM measurement is associated with a second cell or a second beam and is associated with a second time instance.

10. The method of claim 1, wherein the configuration information to comprises an indication of a reporting periodicity for RRM measurements to be included in the RRM measurement report or for predicted RRM measurements to be included in the RRM measurement report, an indication of a number of predicted RRM measurements to include in the RRM measurement report, or an indication of a condition that triggers the WTRU to skip the sending of the RRM measurement report.

11. A wireless transmit/receive unit (WTRU), comprising:
a processor configured to:
send an indication of radio resource management (RRM) measurement prediction capabilities of the WTRU to a network;
receive configuration information, wherein the configuration information comprises information relating to RRM measurements or predicted RRM measurements, wherein the configuration information comprises an indication of a condition associated with the RRM measurements, and wherein the configuration information comprises an indication of information to be included in an RRM measurement report;
determine a first predicted RRM measurement;
determine that a first RRM measurement fulfills the condition associated with the RRM measurements;
determine a second predicted RRM measurement based on the first RRM measurement fulfilling the condition associated with the RRM measurements, wherein the second predicted RRM measurement is associated with a cell that differs from a cell associated with the first RRM measurement, a frequency that differs from a frequency associated with the first RRM measurement, or a time that differs from a time associated with the first RRM measurement; and
send the RRM measurement report to the network, wherein the RRM measurement report comprises information associated with the second predicted RRM measurement.

12. The WTRU of claim 11, wherein the configuration information comprises a condition associated with the predicted RRM measurements, and wherein the processor is further configured to:
determine that the first predicted RRM measurement fulfills the condition associated with the predicted RRM measurements; and
determine a second RRM measurement based on the first predicted RRM measurement fulfilling the condition associated with the predicted RRM measurements, wherein the second RRM measurement is associated with a different cell, a different frequency, or a different time than the first predicted RRM measurement; and
wherein the RRM measurement report comprises information associated with the second RRM measurement.

13. The WRTU of claim 11, wherein the second predicted RRM measurement is determined based on the first predicted RRM measurement.

14. The WTRU of claim 11, wherein fulfillment of the condition associated with the RRM measurements comprises a measured cell quality of a serving cell being below a threshold, a measured cell quality of a neighboring cell being above a threshold, or a measured cell quality of the serving cell being less than a measured cell quality of a neighboring cell by a threshold amount.

15. The WTRU of claim 12, wherein fulfillment of the condition associated with the predicted RRM measurements comprises a predicted cell quality of a serving cell being below a threshold, a predicted cell quality of a neighboring cell being above a threshold, or a predicted cell quality of the serving cell being less than a predicted cell quality of a neighboring cell by a threshold amount.

16. The WTRU of claim 11, wherein the indication of RRM measurement prediction capabilities comprises an indication of one or more frequencies supported by the WTRU, an indication of one or more cells for which the WTRU can predict RRM measurements, or an indication of a beam prediction type supported by the WTRU.

17. The WTRU of claim 11, wherein the RRM measurement report comprises a number of predicted RRM measurement samples and an indication that the predicted RRM measurement samples are predicted RRM measurement samples.

18. The WTRU of claim 11, wherein the RRM measurement report comprises a number of predicted RRM measurement samples that have a highest cell quality, a mean or median of a plurality of predicted RRM measurement samples associated with a prediction time window, or an indication of a range of the plurality of predicted RRM measurement samples.

19. The WTRU of claim 11, wherein the first RRM measurement is associated with a first cell or a first beam and is associated with a first time instance, and the second predicted RRM measurement is associated with a second cell or second beam, and is associated with a second time instance.

20. A method performed by a wireless transmit receive unit (WTRU), the method comprising:
sending an indication of radio resource management (RRM) measurement prediction capabilities of the WTRU to a network;
receiving configuration information, wherein the configuration information comprises information relating to RRM measurements or predicted RRM measurements, wherein the configuration information comprises an indication a condition associated with the predicted RRM measurements, and wherein the configuration information comprises an indication of information to be included in an RRM measurement report;
determining a first predicted RRM measurement;
determining that the first predicted RRM measurement fulfills the condition associated with the predicted RRM measurements;
determining a second RRM measurement based on the first predicted RRM measurement fulfilling the condition associated with the predicted RRM measurements, wherein the second RRM measurement is associated with a cell that differs from a cell associated with the first predicted RRM measurement a frequency that differs from a frequency associated with the first predicted RRM measurement, or a time that differs from a time associated with the first predicted RRM measurement; and
sending the RRM measurement report to the network, wherein the RRM measurement report comprises information associated with the second RRM measurement.
